(19) United States
(12) Patent Application Publication
(10) Pub. No.: US 2002/0114331 A1
(43) Pub. Date: Aug. 22, 2002

(54) Method and system for delivering media selections through a network

(76) Inventors: Kwok Wai Cheung, Taipo (HK); Kwong Wing Raymond Chan, Tuen Mun (HK); Kwun Chung Chan, Tuen Mun (HK); Cheuk Yin Tam, Tuen Mun (HK); Chun Hay Chan, Fanling (HK); Chi Ho Ng, Kwai Chung (HK)

Correspondence Address: James A. LaBarre, BURNS, DOANE, SWECKER & MATHIS, L.L.P., P.O. Box 1404, Alexandria, VA, 22313-1404, US

(21) Appl. No.: 09/993,632

(22) Filed: Nov. 27, 2001

(30) Foreign Application Priority Data
Dec. 13, 2000 (IB) PCT/IB00/01857

(51) Int. Cl. H04L 12/56

(52) U.S. Cl. 370/390; 370/432

(57) ABSTRACT

In a large-scale video-on-demand (VOD) system, the scalability and the provision of truly interactive functions are two difficult problems which have not been resolved satisfactorily. It is easy to provide fully interactive functions using unicast streams but these systems are limited in their scalability which affect the cost of service provisioning. Batching systems based on multicast streaming, on the other hand, can increase the scalability but it is difficult to provide interactive functions on these systems. This invention provides a media delivery system having a novel architecture aiming at serving millions of users in a metropolitan area. It features hybrid multicast-unicast streaming to achieve both scalability and full interactivity through the provision of distributed interactive servers, which cached the multicast media streams generated by the media servers. The interactive servers may also provide fault tolerant routing and error recovery.

### FIELD OF THE INVENTION

This invention relates to networked multimedia delivery system. More particularly, this invention relates to a media delivery system for delivering media selection to a plurality of media client over a hybrid multicast/unicast network.

### BACKGROUND OF THE INVENTION

In a true Video-on-Demand (VOD) system, users are allowed to view any video programs at any time and perform any VCR-like interactive functions, such as fast forward/fast rewind, jump forward/jump rewind, slow motion and pause. It can be easily achieved by dedicating a channel to each user. However, this method is very expensive, inefficient and not scalable. Thus, multicast delivery is regarded as one of the solutions to reduce the cost and increase the scalability of a large-scale VOD system. A multicast stream can be shared by a large number of users. Unfortunately, it is difficult to implement interactive functions for multicast streams. It is a challenging and hot topic in recent years as to find out how to satisfy one user's interactive requests without affecting other users in the same multicast group.

Many researches have tried to solve this problem. One of the studies is to provide limited VCR functions based on the buffer size of the set-top box. Interactive functions such as fast forward can only be performed by using the frames already stored in the buffer. Thus, a large amount of buffer is needed in order to get better VCR functions.

Furthermore, this technique cannot serve certain interactive functions such as jump forward/backward which involve a change in the buffer content. In another study, it is proposed that user interactions can be handled by creating a unicast stream. This new stream may be held on till the end of the video. It means that all the users may eventually hold an individual stream rather than share the same multicast stream. Thus, the scalability is reduced or many interactive requests may be blocked. Such problems limit the usefulness of such systems, particularly in the case when such systems are implemented in metropolitan areas having millions of users.

Therefore, it is an object of this invention to resolve at least some of the problems at set forth in the prior art. As a minimum, it is an object of this invention to provide the public with a useful choice.

### SUMMARY OF THE INVENTION

Accordingly, this invention provides a method for delivering media to a plurality of media client having a buffer for caching media of a selected media stream within one stream interval and processing capability for playing the media in a multicast media stream through a network, including the steps of:

generating plurality of multicast media streams, wherein each mulicast media stream is repeated at regular stream intervals;

joining the media client to a selected multicast media stream in response to a selection request from the media client;

caching the buffer of the media client continuously with unplayed media in the selected multicast media stream; and

caching the selected multicast media streams in at least one interactive server,

such that interactive requests and/or errors playing the media in the media client are handled by the interactive server or the media server.

It is another aspect of this invention to provide a system for delivering media selection to a plurality of media clients having a buffer for caching media of a selected media stream within one stream interval and processing capability for playing the media in a multicast media stream through a network, including

at least one media server for generating a plurality of multicast media streams, wherein each multicast media stream is repeated at regular stream intervals, and the media client is joined to a selected multicast media stream in response to a selection request from the media client

at least one interactive server for caching the selected multicast media stream

such that interactive requests and/or errors in playing the media in the media client are handled by the interactive server or the media server.

### BRIEF DESCRIPTION OF THE DRAWINGS

Preferred embodiments of the present invention will now be explained by way of example and with reference to the accompany drawings in which:

FIG. 1 shows the overall architecture of the media delivery system of this invention.

FIG. 2 shows the media stream scheduling of a particularly preferred embodiment of this invention generated by a media server.

FIG. 3 shows how the media client mergers back to the multicast media stream after an interactive operation is performed.

FIG. 4 shows the pause operations, and FIG. 5 shows the corresponding change of the media client's buffer during a pause operation.

FIG. 6 shows the change in the media client's buffer during a slow motion operation.

FIG. 7 shows how to determine the suitable multicast media stream after a fast forward operation.

FIG. 8 shows the difference between play-point for fast forward operation and normal play back operation.

FIG. 9 shows the difference between play-point for fast rewind operation and normal play back operation.

FIG. 10 shows how to determine the suitable multicast media stream after a jump forward operation.

### DETAIL DESCRIPTION OF PREFERRED EMBODIMENTS

This invention is now described by ways of example with reference to the figures in the following sections. List 1 is a part list so that the reference numerals may be easily referred to.

Although the following description refers the media or the media selections to be delivered is video, it is expressly understood that media in other forms may also be delivered in the system of this invention instead of video, for example audio, or their combination.

1. System Architecture

1.1 Overview

The overall system architecture of the media delivery system (10) of this invention is shown in FIG. 1. The system is composed of four main components:

a) at least one media server. The media server may be a stand alone server or can be a member of the Video Server Cluster VSC (12) as shown in FIG. 1;

b) a plurality of media clients (14) being Client Stations CS;

c) a network (16) which may be represented as a Multicast Backbone Network MBN (20) and a plurality of Local Distribution Networks LDN (22); and

d) at least one interactive server (18) being the Distributed Interactive Server (DIS).

Note that the MBN (20) can use any arbitrary topology that supports the multicast protocol. The ring structure shown in FIG. 1 is used for simplicity and should not be interpreted that a token-ring network is required for this invention.

1.2 Video Server Cluster VSC (12)

The role of the VSC (12) is to generate the multicast media streams for the entire system. Each VSC (12) consists of at least one and preferably 5 to 15 media servers. The number of media servers in the cluster may be altered as desired.

Preferably, each media server stores part of the video content in a simple striped format with parity added for forward error correction, like RAID 5. This allows a simple error recovery if the CS (14) missed out one video block out of the parity group. Also, the entire VSC (12) can still be operational even when some of the media servers are down, achieving some degrees of fault-tolerance. Other known stripping scheme may be employed in this invention.

The video blocks sent by the VSC (12) are preferably interleaved randomly to minimize the impact of burst block errors and increase system security. Since blocks are most likely to drop in a busty manner, by interleaving the packets sent by the VSC (12), missing packets are scattered more evenly. Hence, the simple parity scheme may be able to recover most, if not all of the missing packets.

In addition, block interleaving discourages eavesdroppers to capture the video blocks for viewing. A pseudo random sequence may be used for generating the random interleaving: the generating key of the sequence is passed to the CS (14) by a public key encryption algorithm during channel establishment. As a result, the CS (14) can reorder the video sequence from the regenerated pseudo random sequence.

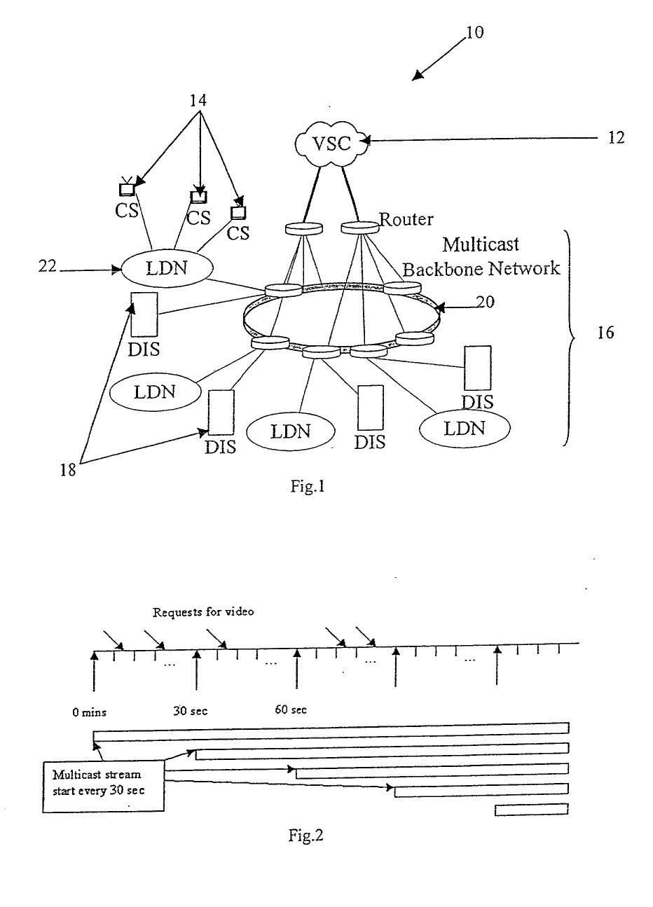

To provide interactive functions to the user, the multicast media streams are repetitively started at fixed regular stream intervals, for example, every thirty to sixty seconds, at the VSC (14) to serve a plurality of media streams to the majority of customers not performing any interactive functions. The media stream scheduling of thirty seconds stream interval is shown in FIG. 2.

The stream interval may be chosen at any desired value basing on the scale and the performance of the system (10). However, the stream interval is preferably set at around 30-60 sec, such that the average start up time may be around 15-30 sec, which is acceptable. Although a large number of multicast media streams are needed, it is worthwhile to do so as it can provide a better quality of service to users and can reduce the buffer requirement at the client side for fully interactive functions. Moreover, with more multicast media streams, the number and the holding time of the unicast streams required for providing interactivity and merging may be reduced.

1.3 Client Station CS (14)

Each CS (14) should have a buffer that can hold media contained in the multicast media streams for up to one stream interval of video blocks. For stream interval equals to 30 sec and MPEG-2 video (2 to 4 Mb/s), that amounts to ˜8-15 MB. With a simple parity for error correction, such as 10 servers with 1 as parity, the buffer required is around 15*10/9 or 16.7 MB. Therefore 32 MB of buffer for each CS appears to be sufficient.

Other than memory requirement, each CS (14) should have a network connection such that the media streams can by delivered to CS (14). The network connection is preferably broadband network connection which can allow ˜1.5 to 2 times of the MPEG-2 transmission rate. Furthermore, each CS (14) should have enough processing capability for playing the media in the multicast media stream. A low-end equipped with Pentium-266 together with a hardware or software MPEG-2 decoder is found to be satisfactory.

1.4 Network (16)

1.4.1. Multicast Backbone Network MBN (20)

There is no particular requirement on the underlying network (16), other than that it should be capable of supplying enough bandwidth for delivering the multicast media streams to CS (14). In a real-life application, MBN (20) may be responsible for handling several thousands of multicast streams for distribution to the CS (14) through the LBN (22).

Preferably, the MBN (20) is connected to the LDN (22) by a high-speed router. Each router should be capable of running the desired multicast routing protocol such as PIM, MOSFF, DVMRP etc. Ideally, the MBN (20) should be fault tolerant and can be re-routed to alternate routes when necessary. The current IP over DWDM network proposals may be used as they seem to provide such a desirable characteristic. In general, the higher the bandwidth of the backbone network, the more media streams it can serve to the users.

1.4.2 Local Distribution Networks LDN (22)

The LDN (22) carries the multicast media streams down to each CS (14), pruning the streams down the way whenever they are not needed. A simple tree network may be sufficient for such purpose.

1.5. Distributed Interactive Server DIS (18)

The DIS (18) are mainly responsible for error recovery and generating unicast contents in response to interactive requests submitted by CS (14), by caching the multicast media streams. Although these functions may be performed by VSC (12), they are preferably performed by DIS (18) to reduce overall server and network load.

Since each multicast stream provided by VSC can be viewed by virtually unlimited number of users, while unicast stream for interactive functions is not, a distributed approach is chosen so that the system is more scalable.

One of the functions of the DIS (18) is handle errors in playing the media in CS (14), including transmitting any video blocks that the CS (14) has not received. When the CS (14) failed to reconstruct tile missing video block, it sends a request to the DIS for the missing video block.

As the DIS (18) is distributed and it is closer to the CS (14), the packet delay may be minimized and this may improve the response time of the interactive functions and the success rate of retransmission. The multicast stream provides most of the traffic. It was found in related studies that less than 2% of users perform interactive functions at one time. Therefore, a low-end DIS (18) may be sufficient for the media delivery system (10).

2. Service Provisioning

The architecture of media delivery system (10) may provide three distinct services Class A, B, and C unified in one single framework.

Class A service is similar to the current cable TV service. Users can watch any broadcast channels in a non-interactive manner. To support Class A service, the media delivery system (10) should be capable of supporting hundreds of non-interactive multicast channels. This is provided (as also offered in many other architectures) by standard IP multicast channels over the broadband infrastructure. The key issue to be resolved is the handling of error retransmission. In this context, Class A service is provided by the VSC (12) using multicast IP streams and distributed to the CS (14) via the network (16). Error recovery and retransmission may be handled by the DIS (18) at each LDN to improve error retransmission.

The Class B service aims at supporting limited media (say hundreds of hours of MPEG-2 programs) in a fully interactive manner with high user scalability. This is provided by the hybrid multicast-unicast streaming technology of this invention that a modest amount of system resources may be required to support a large number of users. This service is particularly desirable for metropolitan areas where millions of users may want to see certain media (such as movie, sports or musical event) without little or even no restriction. In the media delivery system (10) of this invention, several hundred hours of video contents (MPEG-2) can be supported cost effectively for interactive multicast distribution currently.

Class B service is the most complicated and will be explained in the sections below.

The Class C service aims at offering unlimited content to a fixed number of users. This service concept is similar to many existing offerings based on a unique unicast stream for each viewer. The service unfortunately is unscalable in the sense that the service provisioning cost is fixed per user and is also fairly high at the current technology level. However, when this service is bundled with the previous two DINA services, there may be only a small percentage of the entire viewers requesting for this service, thus the overall system cost may be reduced drastically.

Class C service is handled in the following manner. When a certain CS (14) requests for a Class C service, a dedicated interactive request is submitted by the CS (14) asking for a dedicated media. The local DIS (18) will first be checked to see if there exists a copy of the dedicated media stored at the local cache of DIS (18). If yes, the local DIS (18) will service the request directly by starting a unicast stream. If not, the user manager will initiate a request to the VSC (12). The VSC (12) will distribute the content via a unicast stream to the CS (14) requesting the service, either directly from the VSC (12) or indirectly to the DIS (18). Interactivity is handled by the VSC (12) or the DIS (18). The cache implemented at the local DIS (18) aims at reducing the number of requests to the VSC and the backbone bandwidth required according to the usage statistics of the media.

3. Interactive Functions

Interactive functions, including fast forward, fast rewind, jump forward, and jump backward, for the CS (14) may be performed with a dedicated unicast stream from the DIS. Such interactive functions are provided in the Class B service.

In general, when the CS (14) requests an interactive function, the CS (14) will first leave the multicast group it currently belongs to, then request a unicast stream to handle the interactive functions. When the CS (14) finishes the interactive function, it first uses the unicast stream for normal playback, but at a higher, say ˜1.5 to 2×, pump rate. As a result, the CS's (14) buffer will keep filling up and it will be fall after one or two time slots. At that point the CS (14) will close the unicast stream to rejoin a suitable multicast steam. Although the unicast stream may be left open, this will increases the network load.

In order to provide a limited amount of media to an unlimited number of users in a fully interactive manner, the batching concept is utilized in this invention, so that the users may share the same video stream at the same time while interactive functions may still be performed. This may allow one multicast stream to serve many users and reduce both the server and network.

Three types of streams are defined in Class B service: 1) M(i)-stream—which stands for multicast media stream for normal play starting at the beginning of the i-th stream interval; 2) I-stream—which stands for interactive unicast stream opened for the interactive functions requested by any user; 3) J-stream—which stands for merging unicast stream used by a user to merge back to the M(i)-stream.

When a user engages in an interactive function, a new unicast stream may be provided to the user according to what interactive request is raised. Thus an unicast stream is said to have split from the original multicast stream. The splitting operation is straightforward as a new unicast stream is provided to handle the requested interaction.

On the other hand, the merge operation is a lot more complicated and is extremely important as it allows a client on a unicast stream to merge back to the M(i)-stream and release the I-stream after performing the interactive function. A great improvement in the VOD interactive feature may be achieved because the merging operation reduces the number of unicast streams. It in turns allows the same number of streams to serve more users' interactive requests, thus better quality of service scalability may be achieved.

The architecture of the media delivery system (10) can ensure that all the clients can merge back to M(i)-stream provided that the following requirements are met: 1) the CS (14) buffer is large enough to hold all the frames within one stream interval (say 30-60 sec), 2) the J-stream can transmit at a higher rate than the M(i) streams and therefore can fill up the necessary buffer before merging.

As an example, consider a 30-sec MPEG-2 (4.7 Mbps) video, the buffer required is 18 MB (30*4.7/8). The J-stream is opened as soon as a user has finished all interactive functions and returns to normal play. The J-stream then transmits frames at a faster rate f. Since the incoming data rate is faster than the consumption rate r, the buffer will fill up. f can be chosen with different values according to the network architecture. Network with more bandwidth can support a larger f, which means that the client can merge back to the M(i)-stream in a shorter time.

Assume the buffer is being filled up at a rate of (f−r) Mbps. In the worst case, the required time T_{Fill} to fill up the buffer is,

$${T}_{Fill} = \frac{buffersize \times 8}{f - r} sec$$

For an example, if f=1.5*4.7 Mbps, then T_{Fill}=60 sec.

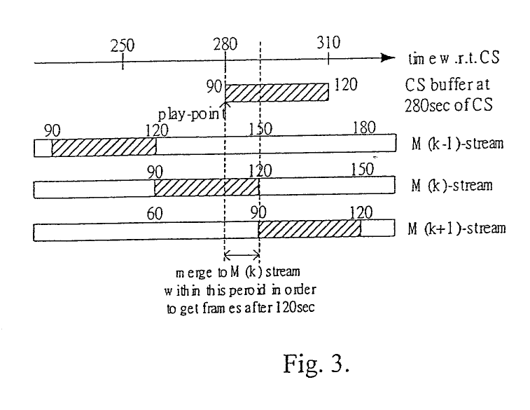

Once the buffer is filled up, the client must be capable of merging back to a M(i)-stream, which is shown in FIG. 3. Suppose that after some interactive action and J-stream transmission, the buffer has been filled up at an arbitrary time mark 280 sec relative to the CS (14). The current play-point of the stream is at 90 sec so the CS (14) buffer stores the frames from 90 sec to 120 sec of the stream. The CS (14) then leaves the J-stream as no more data can be stored, thus freeing up a J-stream to serve other users.

Since the stream interval between the M(i)-streams is the same as the CS buffer size, an M(i)-stream with the current play-time that is within the CS buffer time mark can always be found. Since CS will have to continue to play frames beyond what have been buffered, it can merge back to the appropriate M(k)-stream. By doing so, it can start to receive frames at 120 sec of the M(k)-stream (i.e. at time mark 290 sec relative to the CS). At that time, 10 seconds of buffer space in CS can be freed as the frames from 90 sec to 100 sec have already been played. Thus, this client is successfully merged back to the shared M(k)-stream.

The operations of each interactive function that may be preferred to be performed in the media delivery system (10) of this invention will now be described in the following sections.

Play/Stop

For normal play back, the CS (14) first sends a play request to VSC (14), then joins the multicast media stream and finally wait for VSC video data. While for stop, CS just simply tells the VSC and leaves the selected multicast media stream. During the play time, the CS buffer is continuously filled by the media in the selected multicast media stream.

To improve the benefit of multicast delivery, the VSC (12) preferably waits for some time to fill the buffer of the CS (14) before starting a new selected multicast media stream when a selection request is raised by the user.

Pause

Pause keeps the play-point at its current position. During Pause, the CS buffer continues to receive data from the M(i)-stream, while no data is consumed. Thus, data will accumulate at the buffer. If normal-play is resumed before the CS buffer is full, the CS (14) can continue to receive data from the same M(i)-stream. Only the play-point position in the buffer is changed. If Pause continues until buffer is full, the CS (14) does nothing after the buffer is filled up. It keeps the frames in the buffer for merging. Once Resume is activated, it will try to find the appropriate M(i)-stream to merge. The merge operation is the same as what has been described in Section C. Suppose the original stream is M(k) and the Pause time is T_{Pause}. The algorithm is as follows:

If

m×stream interval≦T_{Pause}<(m+1)×stream interval,

then

merge to M(k+m)stream

where m should normally be positive as the CS (14) rejoins the later multicast streams for it to maintain the same position in the video. When the play-point is paused near the end of the stream and the pause time is large, there may be a wrap around of the streams and m can take on negative values.

Slow Motion

Slow Motion is to play a stream at a slower speed, e.g. 0.5×. During the slow motion, data consumption rate is smaller than the arrival rate. Thus data will be accumulated in the buffer. Similar to pause, if playback is resumed before the CS buffer is full, the CS (14) can continue to receive data from that M(i)-stream. If slow motion continues until the buffer is full, the CS (14) must leave the current M(i)-stream. CS (14) will continue to play slow motion up to the end of the buffer. Then CS (14) needs to join the next stream in order to get the required frame for continuing the slow motion. It is also necessary for the CS (14) to join the next stream so it can resume normal play at any time.

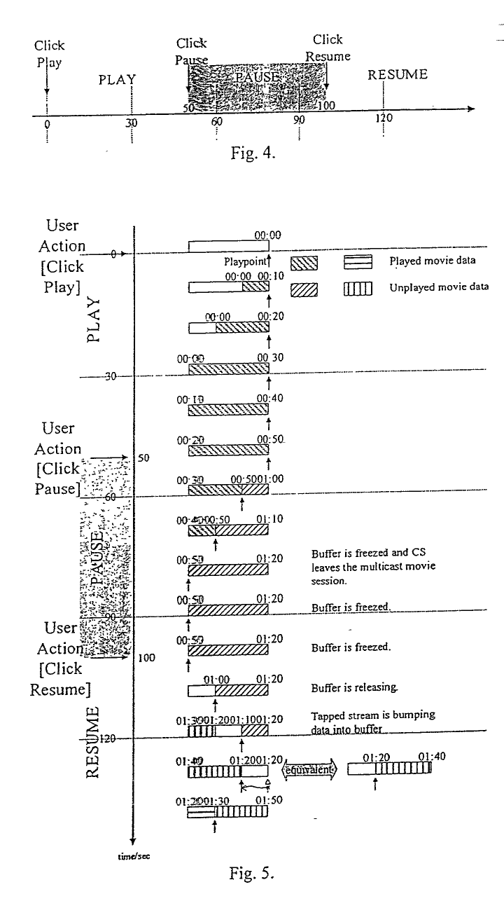

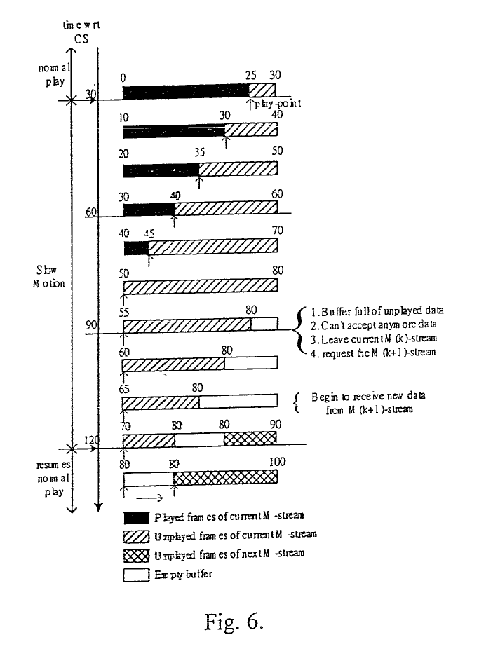

The CS (14) buffer state shown in FIG. 6 helps to explain how slow motion works, which refer to a specific example of slow motion operation. The time mark is relative to the CS (14). In FIG. 4, slow motion at 0.5× begins at CS 30 sec. Afterwards, frames of 5 seconds are played in every 10 seconds of CS time. However, the incoming frame rate is unchanged. Thus, frames of 5 seconds are accumulated in every 10 seconds of CS time. The buffer will be full at 80sec and the CS (14) must leave the current M(k)-stream. Then the CS (14) joins the next M(k+1)-stream to get the missing frames after 80 sec. Since every stream is separated by the same stream interval 30 sec, the frames after 80 sec from M(k+1)-stream will be available at CS 110 sec. The frames received before CS 110 sec duplicate with those in the buffer and will be discarded. At CS 120 sec, the CS (14) resumes normal play. The play-point position will change to the new M(k+1)-stream because the old frames have already been played out and the CS (14) resumes normal play with the incoming frames from the new M(k+1)-stream.

Various Speed Fast Forward/Fast Rewind (FF/REW)

Fast Forward FF or Fast Rewind REW is to play frames faster than the normal speed. In operation, the CS (14) first tries to use the frames in its own buffer to serve FF by skipping some of the frames. If the FF action exceeds the range of the frames in buffer, video provided by the I-stream, which is pre-recorded at different speeds for both forward and reverse direction FF/REW, is utilized. This scheme not only uses bandwidth more efficiently, but also provides various speeds for FF/REW actions (e.g. 1× for rewind, 2×, 4×, etc) which are offered in advanced VCR.

The I-streams containing the prerecorded media are generated and provided by the DIS (18) to the CS (14). For example, when a user requests a 4× FF, the DIS sends the pre-record 4× forward I-stream containing video starting at the required time to the CS (14). CS (14) may then play out the frames without wasting any bandwidth. When the CS ends the interactive function and resumes the normal play, all of the CS buffer is cleared as they are no longer valid. Then, a J-stream is sent by the DIS (18) to transmit data at a faster rate to the CS (14) to fill up the buffer for the merging operation as mentioned in previous section.

In order to know which packet the J-stream should carry in order to match the play-time, the required packet sequence number p should be set equal to (play-time×transmission rate of M(i)-stream)/x, where x is the packet size in bit.

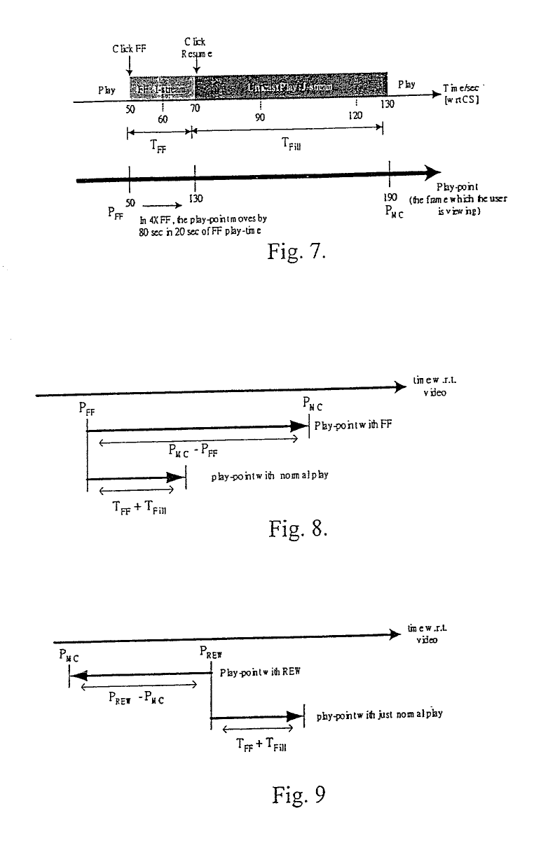

FIG. 7 shows how to determine the suitable M(i)-stream after FF. It can be realized that the actual play-time for, say, a 20-seconds 4× FF is 80 seconds. T_{FF} is the time for FF action and T_{Fill} is the same as defined previously. The play-time has gone for (P_{MC}−P_{FF}), where P_{FF} is the play-time to begin FF and P_{MC} is the play-time to resume the normal multicast M(i)-stream. (T_{FF}+T_{Fill}) is the total time for the split and merge operation. Thus, the stream has been played for a time (T_{FF}+T_{Fill}). In FIG. 8, which shows the difference between play-point for FF operation and normal play back operation, it is shown that [(P_{MC}−P_{FF})−(T_{FF}+T_{Fill})] is the play-time of the new multicast stream ahead of the play-time of the original multicast stream. Suppose the CS is originally in the M(k)-stream. The algorithm for FF operation is as follows:

If

m×stream interval≦(P_{MC}−P_{FF})−(T_{FF}+T_{Fill})<(m+1)×stream interval

then

merge to M(k−m)stream

where m should be positive as it needs to go to the previous stream in order to get the later part of the viewing.

For REW, the operation is similar to FF. If will bring the play-time backwards. The DIS will send a pre-record 1×/2×/4× reverse I-stream to CS and J-stream is also used to fill-up the buffer for merging. However, referring to FIG. 9, now [T_{FF}+T_{Fill}+(P_{REW}−P_{MC})] is the play-time behind the current position. P_{REW} is the time to start REW. The algorithm for REW operation is as follows:

If

m×stream interval≦T_{FF}+T_{Fill}+(P_{REW}−P_{MC})<(m+1)×stream interval

then

merge to M(k+m)stream

where m should be positive in order to go to later stream for the earlier part of the viewing.

Jump Forward/Jump Backward(JF/JB)

Jump Forward is to go to a specific play time immediately. It is an advanced feature in VCD and DVD players which allows user to search frames by directly going to that play-time.

When a user issues a JF request in the media delivery system (10) of this invention, it will first determine whether the target time frame is in the CS buffer. If yes, the user can be served by just moving the play-point position in the buffer to the required frames. If no, a J-stream beginning at the required time will be sent immediately from the DIS. The CS clears (CS) its own buffer and plays frames from J-stream. It accepts the J-stream until the buffer is full, then leaves the J-stream and merges back to a M(i)-stream.

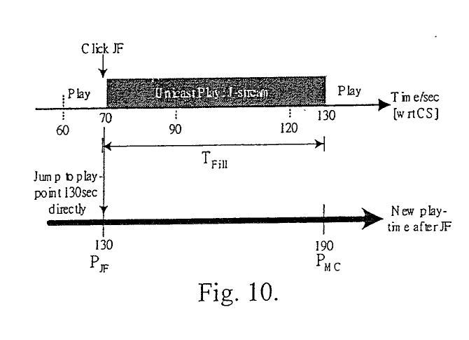

FIG. 10 shows a particular example where a user jump forward from the 70 sec time mark to the 130 sec time mark. P_{JF} is the time when JF starts. Just like the other interactive functions, the CS needs to find the suitable M(i) stream for merging back. The algorithm is similar to FF:

If

m×stream interval≦(P_{MC}−P_{JF})−T_{Fill}<(m+1)×stream interval

then

merge to M(k−m)stream

where m should be positive as it requests the later part of the viewing by jumping back to the previous stream.

The JB operation is similar to JF, except that JB will jump to a play-time at the earlier part of the viewing.

If

m×stream interval≦T_{Fill}+(P_{JB}−P_{MC})<(m+1)×stream interval

then

merge to M(k+m)stream

where m should be positive as it requests the earlier part of the viewing by jumping to the later stream.

It has long been a difficult problem to provide fully interactive functions in a multicast VOD system. The media delivery system (10) of this invention may allow the user to perform fully interactive functions including pause, slow motion, fast forward/rewind, jump forward, and jump rewind which require a relatively low system resources to function. This may be achieved by limiting the number of unicast media streams during the operation of the interactive functions. Therefore, the overall costs of ownership of such VOD systems providing interactive functions may be reduced.

While the preferred embodiment of the present invention has been described in detail by the examples, it is apparent that modifications and adaptations of the present invention will occur to those skilled in the art. It is to be expressly understood, however, that such modifications and adaptations are within the scope of the present invention, as set forth in the following claims. Furthermore, the embodiments of the present invention shall not be interpreted to be restricted by the examples or figures only.

List 1

| Refererrce Numerals | Description |
|---|---|
| 10 | media delivery system |
| 12 | video server cluster |
| 14 | media client |
| 16 | network |
| 18 | distributed interactive server |
| 20 | multicast backbone network |
| 22 | local distributed network |

1. A method for delivering media to a plurality of media client having a buffer for caching media of a selected media stream within one stream interval and processing capability for playing the media in a multicast media stream through a network, including the steps of:
generating plurality of multicast media streams, wherein each multicast media stream is repeated at regular stream intervals;
joining the media client to a selected multicast media stream in response to a selection request from the media client;
caching the buffer of the media client continuously with unplayed media in the selected multicast media stream; and
caching the selected multicast media streams in at least one interactive server,
such that interactive requests and/or errors in playing the media in the media client are handled by the interactive server or the media server.

2. The method of claim 1, wherein the interactive requests and the errors in playing the media in the media client are handled by the interactive server.

3. The method of claim 1, wherein the media in each multicast media streams are sent in packets of data, and the packets are interleaved randomly.

4. The method of claim 1, wherein the stream interval is 30 to 60 seconds.

5. The method of claim 1 further including the step of generating a dedicated unicast media stream from the media server or the interactive server and delivering to the media client in response to a dedicated interactive request from the media client requesting a dedicated media.

6. The method of claim 5, wherein the dedicated unicast media stream is generated from the interactive server if the interactive server contains the dedicated media.

7. The method of claim 5, wherein the dedicated unicast media stream is generated from the media server if the interactive server does not contain the dedicated media.

8. The method of claim 5, wherein the dedicated unicast media stream is generated from the interactive server after the dedicated media is delivered from the media server to the interactive server, if the interactive server does not contain the dedicated media.

9. The method of claim 1, wherein the interactive request includes any one or more of pause, slow motion, fast forward, rewind, jump forward, and jump backward.

10. A system for delivering media selection to a plurality of media clients having a buffer for caching media of a selected media stream within one stream interval and processing capability for playing the media in a multicast media stream through a network, including
at least one media server for generating a plurality of multicast media streams, wherein each multicast media stream is repeated at regular stream intervals, and the media client is joined to a selected multicast media stream in response to a selection request from the media client
at least one interactive server for caching the selected multicast media stream
such that interactive requests and/or errors in playing the media in the media client are handled by the interactive server or the media server.

11. The system of claim 10, wherein the interactive requests and the errors in playing the media in the media client are handled by the interactive server.

12. The system of claim 10, wherein the media in each multicast media streams are sent in packets of data, and the packets are interleaved randomly.

13. The system of claim 10, wherein the stream interval is 30 to 60 seconds.

14. The system of claim 10, wherein a dedicated unicast media stream is generated from the media server or the interactive server and delivered to the media client in response to a dedicated interactive request from the media client requesting a dedicated media.

15. The system of claim 14, wherein the dedicated unicast media stream is generated from the interactive server if the interactive server contains the dedicated media.

16. The system of claim 14, wherein the dedicated unicast media stream is generated from the media server if the interactive server does not contain the dedicated media.

17. The system of claim 14, wherein the dedicated unicast media stream is generated from the interactive server after the dedicated media is delivered from the media server to the interactive server, if the interactive server does not contain the dedicated media.

18. The system of claim 10, wherein the interactive request includes any one or more of pause, slow motion, fast forward, rewind, jump forward, and jump backward.
